(19) United States
(12) Patent Application Publication
(10) Pub. No.: US 2005/0230194 A1
(43) Pub. Date: Oct. 20, 2005

(54) Safety fence at upper part of cab

(76) Inventor: Ryushu Nakamura, Tokyo (JP)

Correspondence Address: Thomas H Osborn;Otis Elevator Company, 10 Farm Springs Road, Farmington, CT, 06032, US

(21) Appl. No.: 10/508,740

(22) PCT Filed: May 6, 2003
(86) PCT No.: PCT/US03/14273

§ 371 Date: Sep. 21, 2004

(30) Foreign Application Priority Data
May 9, 2002 (JP) 2002-133425

(51) Int. Cl. B66B 11/02

(52) U.S. Cl. 187/401

(57) ABSTRACT

A safety fence (11) installed on top of car (12) is formed of multiple holding members (18) that are installed upright on two side plates (15), (15) and back plate (16) of car (12), and columns (19), (19), (20) that are held in a freely vertically extendible manner in said holding members (18). Also, handrails (21), (21), (22) connect the upper ends of said columns, and at the same time, retraining members (23) are set to define the vertical position of the columns with respect to the holding members.

### BACKGROUND OF THE INVENTION

1. Technical Field of the Invention

The present invention pertains to an improved safety fence used to ensure the safety of service personnel working on the upper surface of the ceiling plate of an elevator car.

2. Prior Art

It is well known that service personnel usually stand on the upper surface of the ceiling plate of elevator cars to install equipment or service the elevator. In order to prevent accidental falling of service personnel from the upper surface of the car into the elevator shaft and accidents due to contact of the service personnel with various equipment placed in the elevator shaft, a safety fence is placed on the upper surface of the car.

For example, as shown in FIG. 8, conventional safety fence (1) is fixed on upper surface (3a) of ceiling plate (3) of car (2). Also, as shown in FIG. 9, a collapsible safety fence is arranged above upper surface (3a) of ceiling plate (3) of car (2).

The aforementioned types of safety fences will be explained briefly. First, car (2) will be briefly explaned. As shown in FIG. 8, said car (2) has a boxlike form. Sliding door (4) that can be opened in the left/right direction is arranged on the front side. Also, rectangular multiple reinforcing members (6) are arranged and fixed vertically at prescribed intervals on the outer surfaces of left/right side plates (5), (5). Also, at approximately the central position with respect to the front and back of car (2), car frame member (7) is attached and it runs from the outer side of two side plates (5), (5) to above ceiling plate (3). At the front and rear locations of upper surface (3a) of ceiling plate (3) of car (2), various equipment, such as control equipment (8a), (8b) as well as a blower, cables, safety switches, emergency batteries, etc., are set and fixed.

Said safety fence (1) is located within the perimeter of upper surface (3a) of ceiling plate (3). It is composed of rectangular frame portions (9), (9) that extend in the front and rear directions on the left and right sides, and rectangular rear frame portion (10) between the rear ends of said two frame portions (9), (9). Base portions (9a), (9a), (10a) of said frame portions (9), (9), (10) are fixed with bolts to upper surface (3a) of ceiling plate (3).

Also, collapsible safety fence (1) shown in FIG. 9 is located within the perimeter of upper surface (3a) of ceiling plate (3). However, two side frame portions (9), (9) and rear side frame portion (10) are separated from each other. Their base portions (9a), (9a), (10a) are formed such that they can be easily folded inwardly with hinges. Consequently, when in use, said frame portions (9), (9), (10) are erected and are connected to each other with prescribed connecting members so that their upright orientation is maintained. On the other hand, when not in use, as shown in the figure, the connection between frame portions (9), (9), (10) is released, and the frame is collapsed.

In this way, this constitution is appropriate in the case when the distance between the upper surface of ceiling plate (3) of car (2) and the ceiling of the elevator shaft is short when car (2) is positioned on the uppermost floor of the elevator shaft.

However, in the aforementioned constitution with safety fence (1) attached on upper surface (3a) of ceiling plate (3) of car (2), in order to prevent accidents due to contact of service personnel with the controller and other equipment in the elevator shaft, safety fence (1) is arranged within the horizontal projection plane of car (2) including the thickness of the wall plates that form two side plates (5), (5) and back plate of car (2), reinforcing members (6) of two side plates (5), (5), etc. However, in light of the specifications of the building in which the elevator is installed, specifications of the size, shape and structure of car (2) of elevator vary, and, along with this variation, locations for setting said control equipment (8a), (8b), etc. set on upper surface (3a) of the ceiling plate of car (2) are also changed.

Consequently, due to specifications of car (2), control equipment (8a), (8b), etc. form a restriction on the space for setting safety fence (1). On the other hand, safety fence (1) also limits setting of control equipment (8a), (8b), etc.

Also, since said safety fence (1) and control equipment (8a), (8b), etc. are placed on upper surface (3a) of the ceiling plate of car (2), especially when car (2) is small, the area of upper surface (3a) of the ceiling plate is significantly limited, and it is difficult to ensure a safe operating space for the service personnel.

Also, frame portions (9), (9), (10) of said collapsible safety fence (1) are erected for use, and they fold inwardly when not in use. Consequently, the folding structure is complicated, which raises the manufacturing costs.

### DISCLOSURE OF THE INVENTION

In order to solve the aforementioned problems, the invention provides a safety fence for an elevator car characterized by the fact that it is arranged along the perimeter of the upper surface of the ceiling plate of the elevator car and is made up of multiple columns, wherein said columns of said safety fence are mounted upright on the outer surface of the two side plates and the back plate that form the outside walls of said elevator car.

Consequently, according to the present invention, instead of setting the entirety of the safety fence including columns directly on the upper surface of the ceiling plate of the car, they are mounted on the two side plates and the back plate and projected upwardly from the upper surface of the ceiling plate. Consequently, the work space on the upper surface of the ceiling plate can be made relatively large.

The invention further includes a handrail is connected between said adjacent columns. Consequently, the coupling rigidity between columns is high, and the handrail further improves worker safety.

The invention further includes multiple holding members are fixed to the outer surface of the two side plates or back plate of said elevator car, and said columns are arranged on said holding members in such a way that they can extend freely in the vertical direction. Consequently, when not in use, the columns are pressed down via the holding members, so that they can be accommodated in a position at or below than the upper surface of the ceiling plate.

Also, since said holding members are fixed to said two side plates or back plate, the holding members can be used as reinforcing members for the two side plates and back plate.

The invention is further characterized by the fact that it has restraining members that define the vertical position of said columns with respect to said holding members. Consequently, the height of the columns can be adjusted as desired as appropriate to the given task.

The invention is further characterized by the fact that each of said columns has a telescoping structure; that a second column that holds the inner side of a first column to slide freely up and down is set on said holding member, a first handrail is coupled between said adjacent first columns, a second handrail is coupled to the upper end portion of the second column positioned above said ceiling plate. Consequently, the coupling rigidity between various holding members is improved, enhancing the safety of service personnel.

### BRIEF DESCRIPTION OF THE DRAWINGS

FIG. 1 is an oblique view illustrating an elevator car in a first embodiment of the safety fence of the present invention.

FIG. 2 is an oblique view illustrating an elevator car when said safety fence is not in use.

FIG. 3 is an oblique view illustrating the main portion of the restraining members.

FIG. 4 is an oblique view illustrating the safety fence in a second embodiment.

FIG. 5 is an oblique view illustrating the safety fence in a third embodiment.

FIG. 6 is an oblique view illustrating another example of the restraining members used in the present invention.

FIG. 7 is an oblique view illustrating the main portion of another example of the restraining members.

FIG. 8 is an oblique view illustrating a conventional safety fence.

FIG. 9 is an oblique view illustrating another conventional safety fence.

### DESCRIPTION OF THE PREFERRED EMBODIMENT

In the following, embodiments of the safety fence of elevator car of the present invention will be explained with reference to figures.

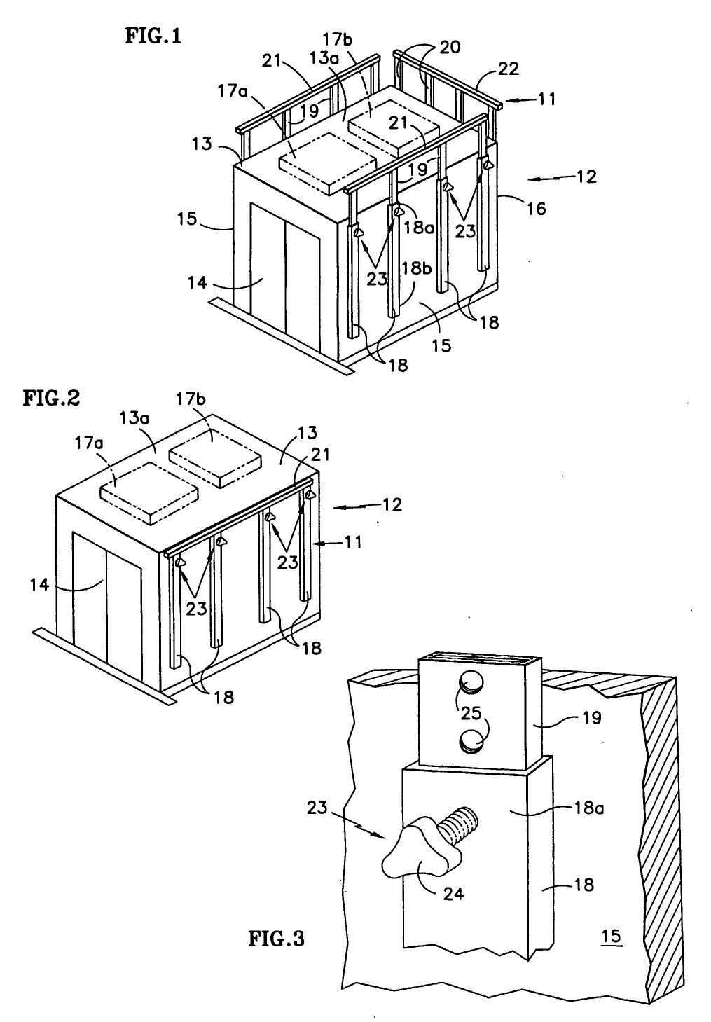

FIGS. 1 and 2 illustrate safety fence (11) in the first embodiment of the present invention. First, car (12), on which safety fence (11) is placed, will be briefly explained. It has the same boxlike form as the conventional car, and it is mainly composed of a bottom plate (not shown in the figure) that forms the bottom wall, ceiling plate (13) that forms the ceiling wall, slide door (14) that is set on the front side and can be opened in the left/right direction, two side plates (15), (15) that form the two side walls, and back plate (16) that forms the rear end wall. Equipment, such as control equipment (17a), (17b), etc., is arranged on upper surface (13a) of said ceiling plate (13).

Said safety fence (11) is formed of the following parts: multiple holding members (18) arranged and fixed along the vertical direction on two side plates (15), (15) and back plate (16) of car (12); columns (19), (19) on the side of two side plates (15), (15) and columns (20) on the side of back plate (16), held in a freely extendible way in the vertical direction; handrails (21), (21), (22) coupled to the upper end portions of said columns (19), (19), (20); and restraining members (23) that define the position for the vertical positions of said columns (19), (19), (20) with respect to various holding members (18).

Said holding members (18) are welded to two side plates (15), (15) and back plate (16), four holding members on each side, equidistantly. Each has an approximately square cylindrical cross section. Also, each upper end section (18a) is set slightly below upper surface (13a) of said ceiling plate (13). And, each lower end section (18b) is set near the lower end of two side plates (15), (15) and back plate (16).

The length of said columns (19), (19), (20) are formed to be about half the length of said holding members (18). They have rectangular cross sections with a size that allows accommodation inside said holding members (18), so that they can slide freely inside said holding members (18).

Said handrails (21), (21), (22) are square bars separated from each other on the side of said two side plates (15), (15) and back plate (16), respectively. The length of each is selected appropriately to ensure connection of the upper end portions of columns (19), (19) on the side of side plates (15), (15) and columns (20) on the side of back plate (16), respectively. Also, as shown in FIG. 2, handrails (21), (21), (22) are such that the maximum descending movement of columns (19), (19), (20) is limited so that the lower surface is in contact with the upper end edge of each holding member (18) when columns (19), (19), (20) are lowered and are entirely accommodated inside holding members (18), respectively.

As shown in FIG. 3, each of said restraining member (23) is composed of knob bolt (24) that is screwed and fixed in the bolt hole at the upper end portion of each holding member (18), and female threaded hole (25) set at the prescribed position of each of said columns (19), (19), (20) for screwing of said knob bolt (24). Multiple female-threaded restricting holes (25) are formed through columns (19), (19), (20) at prescribed intervals in the longitudinal direction.

Consequently, in this embodiment, when a worker stands on upper surface (13a) of ceiling plate (13) of car (12) the service the elevator, first, the worker standing on upper surface (13a) grabs handrails (21), (21), (22) and pulls them up to a prescribed position.

Then, while columns (19), (19), (20) are kept in the pulled-up position, knob bolts (24) are matched to female-threaded restriction holes (25) and they are then screwed in for fastening. As a result, as shown in FIG. 1, columns (19), (19), (20) are fixed and held reliably by means of holding members (18) at the upward extended position above upper surface (13a) of the ceiling plate (13).

As a result, the worker can work safely on upper surface (13a) of the ceiling plate (13). Also, the entire safety fence (11) is not on upper surface (13a) of the ceiling plate. Instead, it is attached along the outer surfaces of two side plates (15), (15) and back plate (16). As a result, the work space of upper surface (13a) is much larger than in the prior art.

As a result, by adopting the aforementioned configuration of the elevator, although the area of upper surface 13a, is small, the maintenance inspection can be carried out easily, and the safety can be improved.

Also, since the entire configuration of safety fence (11) is simplified, said safety fence (11) can be manufactured and assembled very easily. The cost can be cut significantly.

In addition, because said holding members (18) are fixed along the vertical direction on two side plates (15), (15) and back plate (16), they also act as reinforcing members of said plates (15), (15), (16). Consequently, it is possible to increase the rigidity of said plates (15), (15), (16). Also, there is no need to apply specific reinforcing members. This feature improves the manufacturing efficiency of the elevator and can reduce costs.

Also, columns (19), (19), (20) are interconnected by means of handrails (21), (21), (22). Consequently, the coupling rigidity is increased, and the safety of service personnel and the durability are further improved.

When the task is finished and safety fence (11) is no longer needed, the worker can simply reverse the aforementioned operation, that is, while handrails (21), (21), (22) are held, knob bolts (24) are loosened to release columns (19), (19), (20). As a result, columns (19), (19), (20) fall under their own weight together with handrails (21), (21), (22) and are accommodated in holding members (18). As shown in FIG. 2, handrails (21), (21), (22) fall until they make contact with the upper ends of holding members (18), so that they are entirely accommodated below upper surface (13a) of the ceiling plate. Consequently, the space of the portion above car (12) becomes larger, and, when car (12) reaches the top floor, the distance between upper surface (13a) of the ceiling plate of car (12) and the ceiling portion of the elevator shaft is shorter for the elevator.

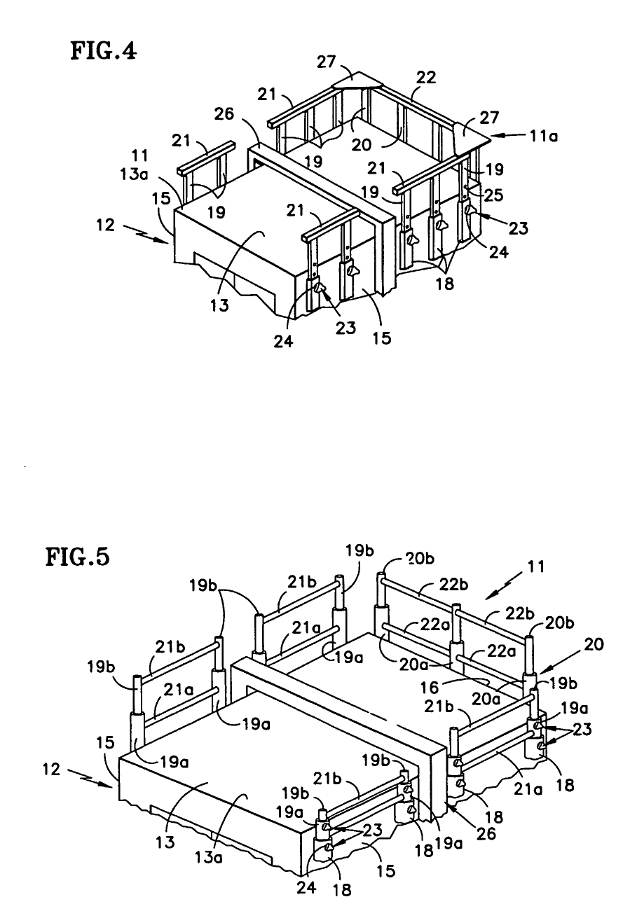

FIG. 4 is a diagram illustrating a second embodiment of the present invention. In this embodiment, car (12) is longer than it is wide, and a car frame member (26) is attached at nearly the center of said car (12) in the outer peripheral front/rear direction and running from the outer side of two side plates (15), (15) to above ceiling plate (13).

On the other hand, the basic constitution of safety fence (11), that is, holding members (18), columns (19), (19), (20) and handrails (21), (21), (22) is the same as that of said first embodiment. However, it is formed as a front portion and a rear portion with said car frame (26) at the center, and the number of columns (19), (19) on each of the two sides is increased. Handrails (21), (21) attached to the upper end portions are separated into front and rear sections. Also, left/right handrails (21), (21) of separated safety fence (11a) on the rear side is connected to handrail (22) on the back side by means of connecting members (27), (27).

Said connecting members (27), (27) are formed from triangular sheets. The two end portions are bonded with bolts to the opposite end portions of said adjacent handrails (21), (21), (22).

Consequently, in this embodiment, by means of connections using connecting members (27), (27), the rigidity is improved with respect to rear-side adjacent handrails (21), (21), (22) and columns (19), (19), (20). Consequently, it is possible to improve the durability of rear-side safety fence (11a), and, at the same time, it is also possible to improve the operating safety.

Also, since connections are formed by means of connecting members (27), (27), when safety fence (11a) is in use, it is possible to have columns (19), (19) on the rear side of two side plates (15), (15) move up/down together with columns (20) on the side of back plate (16) via rear-side handrails (21), (21), (22). This feature facilitates the extension of safety fence (11a) on the rear side.

Also, the lower surfaces of connecting members (27), (27) are in contact with the corner portions of upper surface (13a) of ceiling plate (13) when the safety fence (11a) is lowered, so that further lowering is prevented.

Also, a constitution may be adopted that allows said connecting members (27), (27) to be secured in a freely detachable manner. In this case, each column (19) is accommodated in holding member (18), and handrails (21) are accommodated below upper surface (13a) of ceiling plate (13). On the other hand, when in use, columns (19) and handrails (21) are pulled up and held at a prescribed position for use, while connecting members (27) are attached at the comer portions.

FIG. 5 is a diagram illustrating a third embodiment of the present invention. In this case, columns (19), (19), (20) of safety fence (11) are formed in a 2-step constitution.

That is, holding members (18) fixed by welding or the like on two side plates (15), (15) and back plate (16) are formed in an approximately hollow cylindrical form. Inside said holding members (18), columns (19a), (19b), (20a), (20b) in a telescoping structure are accommodated to be freely extendible vertically. Said holding members (18) are fixed with four on each of two side plates (15), (15), and with three holding members on back plate (16). Also, in addition to said hollow cylindrical form, holding members (18) may also have a hollow, square shape.

Said first columns (19a), (20a) on the outer side are in a hollow, cylindrical shape with a smaller diameter. They are set such that they can slide freely vertically inside holding members (18), and, at the same time, cylindrical first handrails (21a), (22a) are used to connect adjacent first columns (19a), (19a), (20a), (20a). On the other hand, second columns (19b), (20b) on the inner side are formed as small-diameter round rods, and they are set inside said first columns (19a), (20a) in a freely vertically sliding manner. Also, adjacent second columns (19b), (19b), (20b), (20b) are connected to each other with second cylindrical handrail members (21b), (22b). Also, when said second columns (19b), (20b) are lowered so that they are accommodated in said first columns (19a), (20a), they are only slightly above upper surface (13a) of the ceiling plate. Consequently, the constitution is such that second handrails (21b) are located slightly above upper surface (13a) of the ceiling plate.

Also, as in the first embodiment, restraining members (23) made of knob bolts (24) and restraining threaded holes (25) are set between each holding member (18) and first, second columns (19a), (19b), (20a), (20b).

Consequently, in this embodiment, depending on the given task, since first and second columns (19a), (19b), (20a), (20b) are partially or completely pulled up, and said restraining members (23) are manipulated, it is possible to adjust the height of safety fence (11) as desired. Consequently, the practical effects are good. Also, when safety fence (11) is not in use, since second handrail (21b) is positioned slightly above upper surface (13a) of the ceiling plate, the worker can hold said second handrails (21b) while climbing onto or descending from upper surface (13a) before starting or after completing the task. Consequently, this feature also enhances the safety.

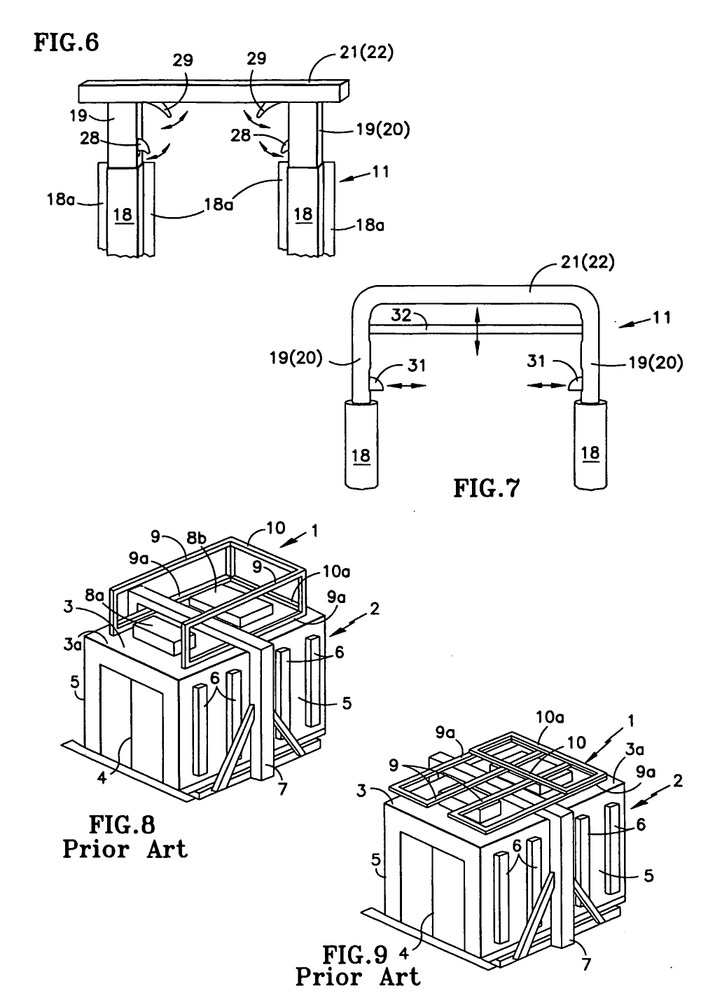

Besides the aforementioned constitutions, said restraining members (23) may have other constitutions. For example, as shown in FIG. 6, hook sections (28), (28) that can engage with the upper ends of holding members (18) can be arranged to project outwardly from the interior at the positions opposite to the upper end portions of columns (19), (20). By means of manipulating levers (29), (29) supported in a freely rotatable manner on the lower portions of handrails (21), said hook sections (28), (28) can be manipulated to be accommodated in or projecting from columns (19), (20) via wires (not shown in the figure).

In this embodiment, holding members (18) have flanged portions (18a), (18a), which are fixed by welding or the like to two side plates (15), (15) and back plate (16) in the longitudinal direction of the ends.

In addition, as shown in FIG. 7, two columns (19), (19) and handrail (21) are by bonding a single piece. Engagement portions (31), (31) are installed via springs (not shown) so that they can enter into or emerge from the upper ends of columns (19), (19) as desired. Also, said engagement portions (31), (31) are made to enter and exit simultaneously via prescribed spring members by means of a one-touch operation to raise or lower manipulating lever (32).

The present invention is not limited to the constitutions of the aforementioned embodiments. It is possible to make changes as desired for the number and cross-sectional shape of holding members (18), columns (19), (20), and handrails (21) corresponding to the size and specifications of elevator car (12). The same is true for the constitution of restraining members (23).

Also, safety fence (11) can also be installed on only two side plates (15), (15) or back plate (16) of car (12). In addition, instead of holding columns (19), (20) in holding members (18) in a freely sliding manner, one may directly fix them erected on the outer surfaces of two side plates (15), (15) and back plate (16).

As explained above, according to the invention, instead of installing the entire safety fence, including columns, directly on the upper surface of the ceiling plate of the car, it can be attached to the two side plates and the back plate and formed to protrude upward from the upper surface of the ceiling plate. Consequently, it is possible to ensure safety for the given task, and it is possible to provide a large work space on the upper surface of the ceiling plate.

The subject invention improves durability, rigidity, and safety by means of handrails that connect adjacent columns to each other.

According to the subject invention, when the safety fence is not in use, the columns are pushed down via holding members so that they can be accommodated in a position at or below the upper surface of the ceiling plate. Consequently, it is possible to adopt the constitution for an elevator that has a small distance between the ceiling plate of the car and the ceiling portion of the elevator shaft.

The subject invention includes holding members which act as reinforcing members on the two side plates and the back plate. Consequently, the utility of the members is increased, so that the cost can be reduced.

The subject invention allows for adjusting the height of the columns corresponding to the specific task by arranging restraining members that restrain the vertical positions of said columns with respect to the holding members.

1. A safety fence for an elevator car (12), the elevator car (12) comprising a ceiling plate (13) having an upper surface (13a) first and second side plates (15), and a back plate (16), an outer surface of the first and second side plates (15) and the back plate (16) forming an outer wall (15a) of the elevator car (12), the safety fence comprising:
multiple reinforcing members (18) of the outer wall (15a), generally perpendicular to the upper surface (13a);
multiple columns (19) wherein one of said multiple columns (19) is mounted for vertical movement relative to a corresponding one of said multiple reinforcing members (18); and
a rail (21) connecting said columns (19) to form a safety fence.

2. (canceled)

3. The safety fence according to claim 1 wherein the columns are extendable to a first height for positioning the safety fence above the upper surface and to a second height for positioning the safety fence below the first height.

4. The safety fence according to claim 3 wherein the second height is even with the upper surface (13a).

5. The safety fence according to claim 1 further comprising a restraining member (23) for releasably fixing the vertical position of the column (19) relative the reinforcing member (18).

6. The safety fence according to claim 1, the columns (19) further comprising multiple telescoping sections (19a, 19b).

7. The safety fence according to claim 1, the rail (21) comprising multiple sections (21, 22).

8. The safety fence according to claim 1 or 7 wherein the safety fence is located beyond a perimeter of the upper surface.

9. The safety fence according to claim 5, the restraining member further comprising an engagement portion (31) for automatically fixing the column (19) in a vertical position relative the reinforcing member (18) when the column (19) has been moved to a desired position.
